(19) United States
(12) Patent Application Publication
(10) Pub. No.: US 2003/0200870 A1
(43) Pub. Date: Oct. 30, 2003

(54) Autofill device applicable to the mixing bowl of a granita or chilled beverages dispenser

(75) Inventors: Gino Cocchi, Bologna (IT); Antonio Vannini, Vergato (IT); Roberto Rinaldi, Castel Maggiore (IT)

Correspondence Address: Richard J. Minnich, Esq., Fay, Sharpe, Fagan, Minnich & McKee, LLP, Seventh Floor, 1100 Superior Avenue, Cleveland, OH, 44114-2518, US

(73) Assignee: ALI S.p.A DIVISIONE GBG

(21) Appl. No.: 10/419,514

(22) Filed: Apr. 21, 2003

(30) Foreign Application Priority Data
Apr. 24, 2002 (IT) GE2002A000034

(51) Int. Cl. A23L 1/00

(52) U.S. Cl. 99/275

(57) ABSTRACT

Granita ices or chilled drinks made from water and a liquid flavoring are mixed in a dispenser equipped with an autofill device that comprises a module packaged in a housing positionable directly on top of the bowl from which the iced or chilled product is dispensed. Water is directed into the module through first feed pipelines, and flavoring through second feed pipelines, whereupon the two liquids are directed along a further pipeline from the respective feed pipelines into the bowl. The presence of the water and flavoring is detected by sensors located on the feed pipelines or the outlet pipeline, or both, and further sensors monitor the level of the mixture in the bowl; a control unit interlocked to the presence sensors will activate a solenoid valve on the first pipelines, and a pump on the second pipelines, to replenish the bowl with the requisite quantities of water and flavoring automatically.

### BACKGROUND OF THE INVENTION

The present invention relates to equipment by which products such as granita ices or chilled drinks are mixed and dispensed on demand, of the type comprising a refrigerated reservoir or bowl filled with water and with a flavoring substance that can be a syrup, or a concentrated fruit juice with or without pulp.

In particular, the invention relates to a modular autofill device applicable to such equipment and serving to replenish the bowl automatically with water and flavoring in predetermined proportions.

The installation of autofill devices on granita dispensers is beset by a problem having its origin principally in the fact that machines of this type take a given length of time to transform a liquid mixture into a relative end product.

The greater the quantity of liquid mixture put in at the start of the chilling period required to produce the granita, the longer the transformation time will become.

If water and flavoring are added subsequently, even in modest quantities, it will not be possible to dispense the end product momentarily. In effect, an ice-based product tends naturally to float, and given that granita is dispensed from the lower part of the bowl holding the liquid mixture, it follows that if the product is dispensed before all of the mixture has been frozen and turned into granita, what emerges from the tap will consist largely of the unfrozen liquids introduced when the autofill function is activated.

It is therefore important that the user should know how to calculate the preparation times and the quantities dispensed, so that the bowl containing the iced product can be replenished in advance. This proves to be genuinely difficult, given the variation in levels of custom from one day to the next, also in ambient temperature, and in other factors attributable to the momentary changes in conditions that will occur during the day.

Accordingly, it is extremely important to provide a device that will replenish the bowl automatically every time the product is drawn off. In effect, the small quantities of water and flavoring introduced each time will be chilled immediately, not least by virtue of the mass of product already in the bowl, and the aforementioned drawbacks thus avoided.

Autofill devices in current use almost invariably include a water-driven mix pump connected directly to the main, by which the flavoring is suctioned generally from a can.

The outlet of the pump is connected to the bowl of the granita dispenser by way of pipelines routed generally together with wires protected internally of a sheath and forming part of electrical circuits serving to operate the pump and monitor the level of flavoring in the can.

The main drawback of such pumps is that, until primed with flavoring, they deliver only water.

Moreover, the pump is in general located remotely from the granita dispenser, so that a relatively long run of pipeline will be needed to connect the autofill device with the bowl of the dispenser to which the mixture of water and flavoring must be conveyed. Given the nature of the pipeline, it is impossible to chill the liquid while being pumped, and this represents a serious drawback.

Accordingly, the object of the invention is to provide an autofill device by which these and other drawbacks of conventional devices can be overcome.

### SUMMARY OF THE INVENTION

The stated object is duly realized in an autofill device according to the invention, applicable to the mixing bowl of a granita or chilled beverages dispenser and comprising a module positionable on the bowl of the dispenser, equipped with feed means conveying water, feed means conveying a liquid flavoring, and connection means located between the bowl and the feed means conveying the water and the flavoring.

The autofill module further comprises electric and electronic circuits that will include a control unit operating in conjunction with sensors able to detect the presence of the flavoring and the water respectively in the feed means or in the connection means, or in both, and with sensors that serve to monitor the level of the mixture in the bowl and to activate the step of replenishing the bowl with the water and liquid flavoring by way of the respective feed means, when enabled by the presence sensors.

### BRIEF DESCRIPTION OF THE DRAWINGS

The invention will now be described in detail, by way of example, with the aid of the accompanying drawings, in which:

FIG. 1 illustrates a granita dispenser equipped with the device according to the invention, viewed in three-quarter perspective from the rear;

FIG. 2 is a diagram showing the internal fluid and electrical circuits of the device according to the invention;

FIG. 3 illustrates the device according to the invention, viewed in three-quarter perspective from the front;

FIGS. 4 and 5 illustrate the device of FIG. 3 viewed respectively in a front elevation and in a side elevation;

FIGS. 6, 7, and 8 are diagrams illustrating the fluid and electrical circuits for three alternative embodiments of the device according to the present invention;

FIG. 9 illustrates the device according to the invention in an embodiment corresponding to the circuit of FIG. 7, viewed in a front elevation.

### DESCRIPTION OF THE PREFERRED EMBODIMENTS

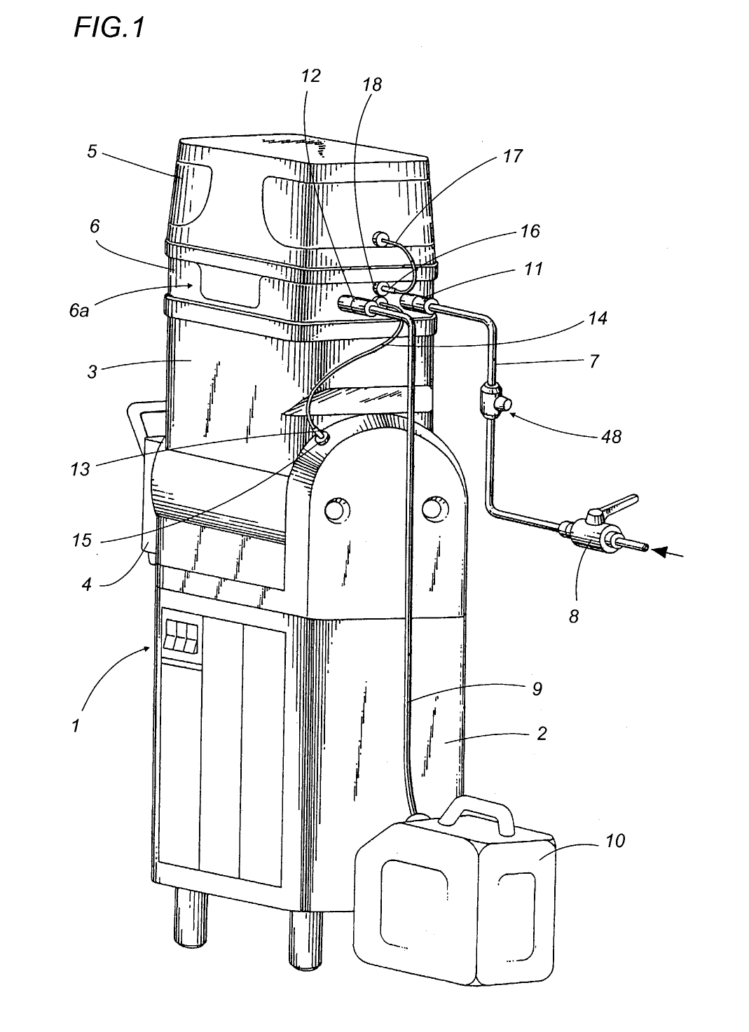

Referring to the drawings, and in particular to FIG. 1, numeral 1 denotes a machine for making and dispensing granita ices.

Such a machine conventionally comprises a base or cabinet 2 housing the motor and condenser of the refrigeration unit, and a motor driving the stirrer (none of which are illustrated).

3 denotes the bowl containing the evaporator of the refrigeration unit and the stirrer (neither of which are illustrated), submerged in the mass of liquid and/or iced mixture.

The bowl 3 is equipped at the front with taps 4 from which to dispense the iced product, and capped by an illuminated lid, or topper 5.

In accordance with the present invention, the granita dispenser 1 is equipped with a module 6 applicable directly to the bowl 3.

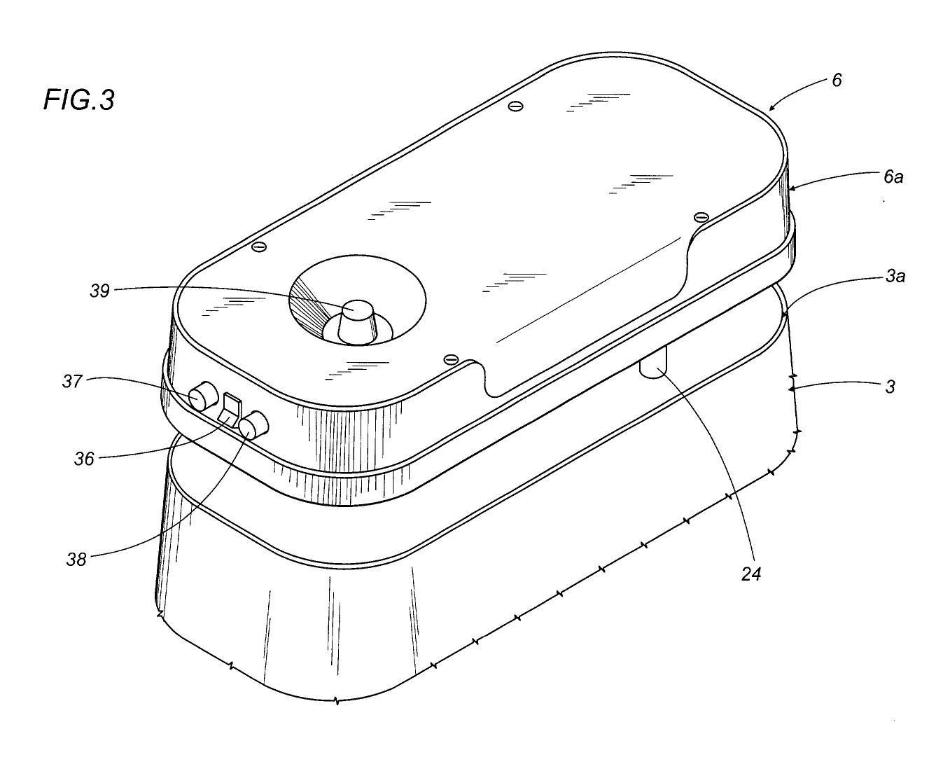

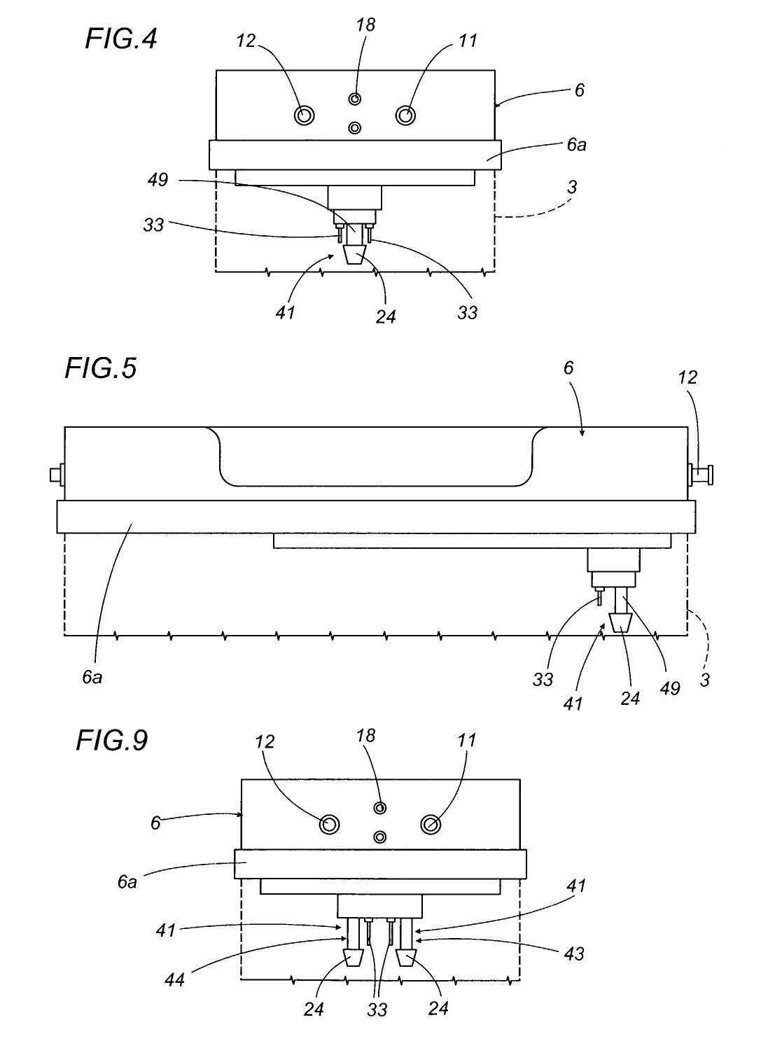

In particular, and as illustrated in FIGS. 1 and 3, the module 6 in question comprises a modular housing 6a, interposed between the topper 5 and the bowl 3, of which the underside affords a skirt 60 creating a recess fashioned so as to receive the top of the bowl 3. Accordingly, the module 6 can be fitted swiftly and simply to the machine, resting directly on the rim 3a of the bowl 3.

Connected to the module 6, for example by means of suitable quick couplers denoted 11 and 12, are a water inlet pipe 7, connected by way of a manually operated valve 8 and possibly a pressure regulating valve 48 to a supply point on the main (not shown), and a pipe 9 immersed in a can 10 containing the flavoring. The valve 48 can be adjusted manually to suit the particular operating conditions.

The module 6 is also connected by means of a jack plug 13 and relative lead 14 to a socket outlet 15 from which power would normally be supplied direct to the illuminated topper 5. In this case, the jack plug 16 and lead 17 of the topper 5 are connected to an auxiliary socket 18 on the module 6.

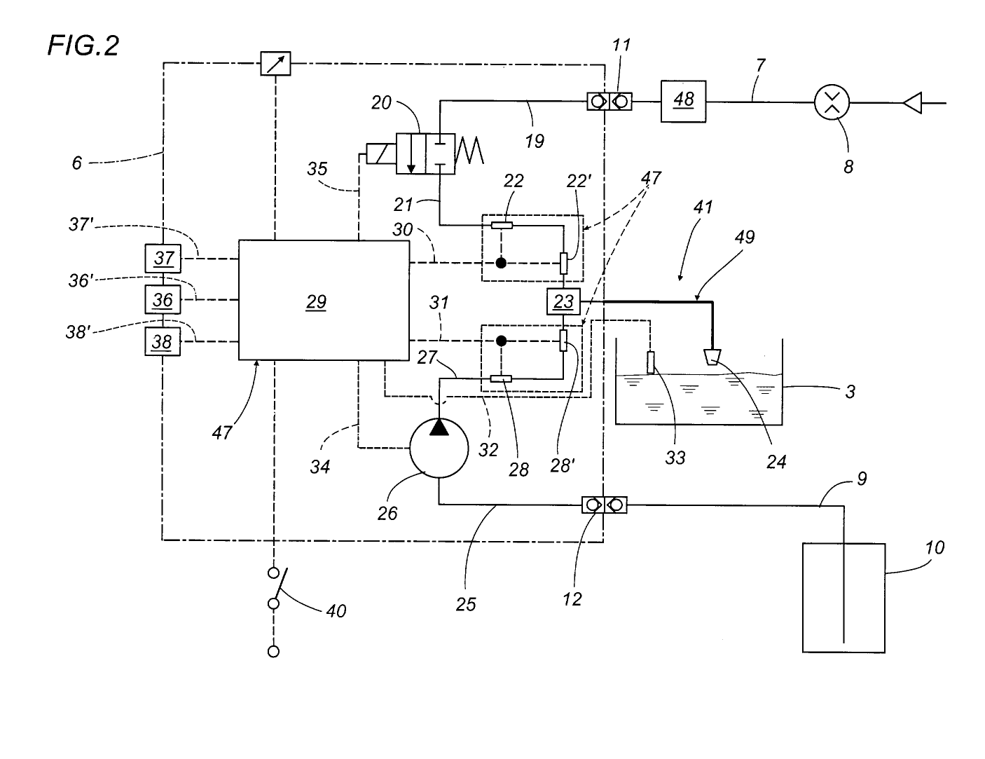

In the example of FIG. 2, water carried from the main along the pipe 7 enters the module 6 by way of the quick coupler 11, which is connected to an internal pipeline 19 connected in its turn to a solenoid valve 20. The solenoid valve is connected by way of a further pipeline 21 to tubular sensors denoted 22 and 22′, of which the purpose will be described in due course, and thence to one inlet leg of a tee or branch fitting 23, of which the outlet leg consists in a pipeline 49 connected to a nozzle 24 discharging into the granita bowl 3.

The fitting 23, the pipeline 49 and the nozzle 24 combine to establish connection means 41 interfaced with the bowl 3.

Similarly, flavoring carried along the pipe 9 immersed in the can 10 enters the module through the relative quick coupler 12, which is connected by way of an internal pipeline 25 to the inlet side of a pump 26 connected in turn on the outlet side, by way of a further internal pipeline 27, to two tubular sensors denoted 28 and 28′ of which the purpose will be described in due course, thence to the second inlet leg of the aforementioned tee or branch fitting 23.

To advantage, the internal pipelines 21 and 27 and the fitting 23 are fashioned from electrically insulating material, whereas the sensors 22-22′ and 28-28′, conventional in embodiment, are made of electrically conductive material and function as respective means by which to sense the presence of water and flavoring in the two pipelines 21 and 27 using the medium of electrical resistance.

The two pipelines denoted 21 and 27 and the two pipelines denoted 19 and 25 combine to establish respective feed means by which water and flavoring are conveyed through the module 6.

29 denotes an electronic control unit piloting the autofill system, to which conductors 30 and 31 coming from the respective pairs of sensors 22-22′ and 28-28′ are connected. Other connections to the control unit 29 include a signal conductor 32 wired to two further sensors 33 monitoring the level of the product in the bowl 3, also power conductors 34 wired to the pump 26, and power conductors 35 wired to the solenoid valve 20.

A switch 36 mounted to the front of the module 6 and connected to the control unit 29 by way of a relative conductor 36′ can be operated in such a way as to deactivate the module 6, and thus allow an appreciable number of granita portions to be dispensed without any risk of the machine releasing quantities of unmixed and/or unchilled liquids.

Also mounted to the front of the module 6 are buttons 37 and 38 connected to the control unit 29 by way of respective conductors 37′ and 38′. These same buttons can be activated by the user to fill the pipelines 21 and 27 with water (button 37) and flavoring (button 38), to the point of engaging the respective sensors 22-22′ and 28-28′. With the two internal pipelines 21 and 27 thus primed, the buttons 37 and 38 can be deactivated manually, or alternatively, the pump 26 can be shut off and the solenoid valve 20 closed by the electronic control unit 29.

The two buttons 37 and 38 are furnished with built-in indicators that light up to warn the user when one (or both) of the liquid ingredients can no longer be detected by the sensors 22-22′ or 28-28′. A buzzer (not illustrated) mounted to the control unit 29 will also sound an audible warning when either of the ingredients is missing.

40 denotes a main on/off switch by way of which the components of the module 6 are connected to the electrical power supply.

Finally, 39 denotes a knob (FIG. 3) connected by way of the control unit 29 to an electronic device regulating the operation of the pump 26, in such a way that the rate of flow can be adjusted manually according to requirements.

The operation of the device thus described will be substantially self-evident.

Having positioned the module 6 on the bowl 3 of the granita dispenser and made the connections to the water supply and to the can 10 of flavoring by attaching the quick couplers 11 and 12, the user proceeds to power up the module 6 by operating the switch 40, then presses the two buttons 37 and 38 to prime the sensors 22-22′ and 28-28′ with the respective liquids.

The electronic control unit 29 will be programmed in such a manner that the operation of the module remains inhibited until the sensors are primed.

At this juncture the autofill sequence can begin. In practice, whenever the liquid level inside the bowl 3 drops to the point of being detected by the relative sensor 33, the solenoid valve 20 opens and the pump 26 comes into operation, directing water and flavoring respectively into the tee or branch fitting 23 and through the outlet pipeline 49 to the nozzle 24, which continues to fill the bowl 3 with a mixture of the two ingredients until the sensor 33 detects that the prescribed level in the bowl 3 has been reached, whereupon the flow is shut off.

The filling operation can be interrupted likewise in the event of the sensors 22-22′ and/or 28-28′ detecting that either one of the two ingredients is missing. This situation is indicated visually by the warning light incorporated into the relative button 37 or 38, and audibly by the buzzer of the control unit 29.

Should the need arise for a considerable number of granita ices to be dispensed in uninterrupted succession, the control unit 29 can be by-passed temporarily by operating the switch 36.

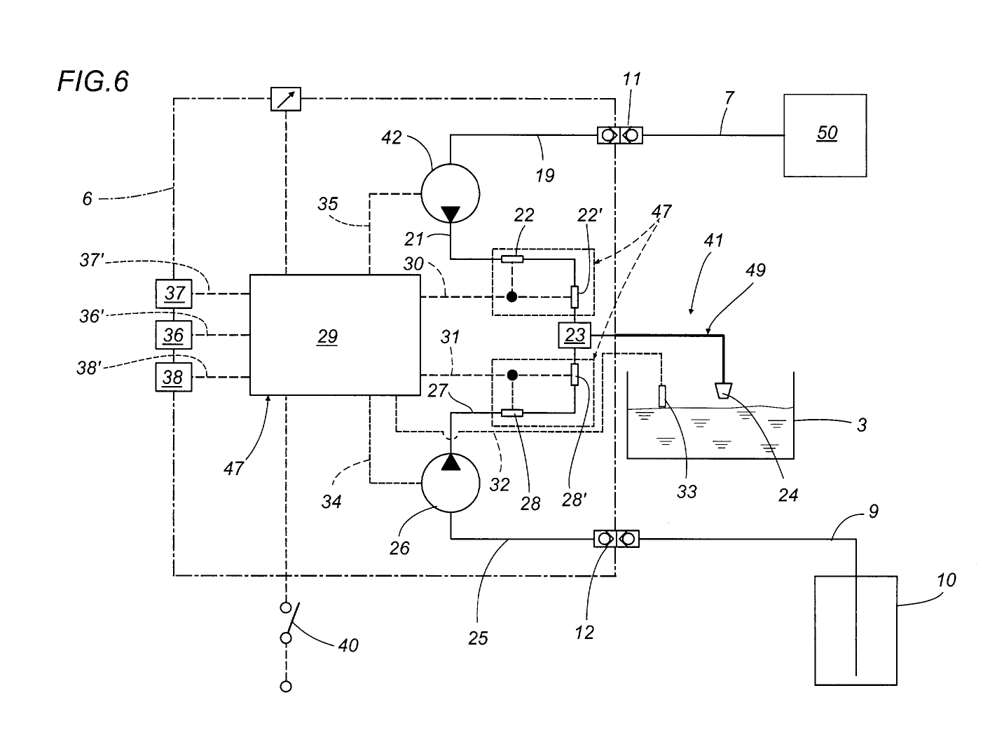

Whilst the pipe denoted 7 is described above as being connected to the water main, the connection might be made alternatively, as illustrated in the example of FIG. 6, to a supply of water contained in a tank 50 (a storage can, for example). In this instance the solenoid valve 20 will be replaced by a pump 42 similar in all respects to the pump 26 already mentioned.

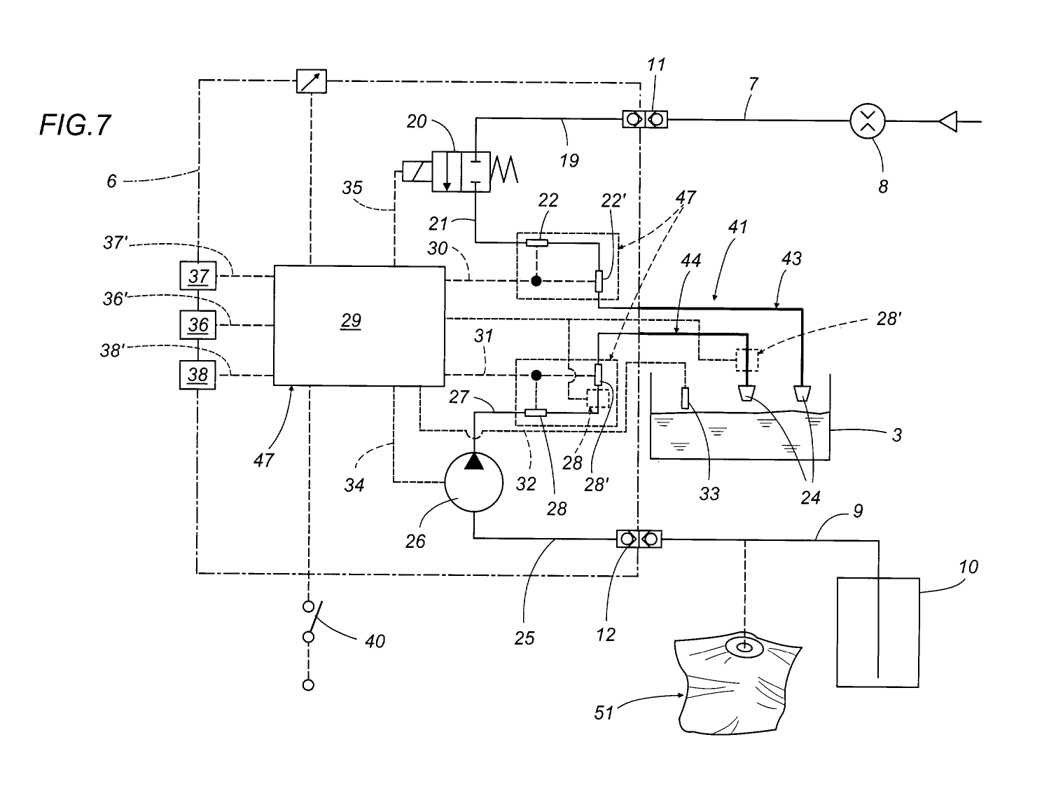

In the example of FIG. 7, connection means 41 comprise a first pipeline 43 by which water coming through the relative internal pipelines 19 and 21 is directed into the bowl 3 and discharged from a relative first nozzle 24, and a second pipeline 44, independent from the first, by which the flavoring suctioned through the relative pipelines 25 and 27 is directed into the bowl 3 and discharged from a second nozzle 24. It will be seen in this instance that the water and flavoring do not mix in the one pipeline 49 before discharging from one nozzle 24, as in the example of FIG. 2, but are discharged separately into the bowl 3 and then mixed.

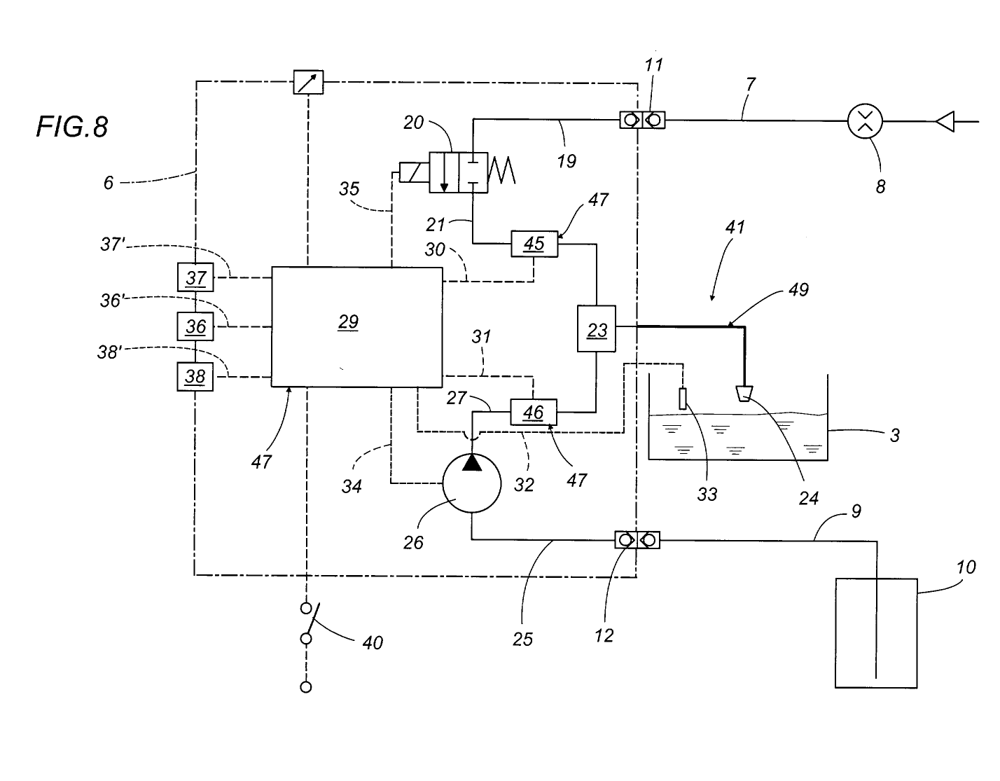

The control unit 29 and the sensors 22-22′ and 28-28′ combine to establish electric and electronic means, denoted 47 in their entirety, of which the static type sensors 22-22′ and 28-28′ might also be replaced by dynamic sensors such as flow meters 45 and 46, as in the example of FIG. 8. The first flow meter 45 is installed on the one pipeline 21 and serves to measure the mass or volume of water passing through, whilst the second flow meter 46 is installed on the other pipeline 27 and serves to measure the mass or volume of flavoring.

In an alternative embodiment of the device (not illustrated), the electric and electronic means 47 might incorporate sensors 22-22′ and 28-28′ and flow meters 45 and 46 alike, installed on one or both pipelines 21 and 27.

In the example of FIG. 7, finally, at least one of the two flavoring sensors 28-28′ might usefully be placed on the second outlet pipeline 44, near to the nozzle 24, as illustrated by phantom lines. This type of solution will be advantageous in the event that the flavoring is drawn by the pump 26 from a sealed bag 51 which, as experience teaches, can be difficult to empty completely by suction when nearing depletion.

The present invention obviously is not limited to the examples described and/or illustrated but will embrace all such alternative solutions as may fall within the broader scope of the essential concept, namely that the means by which water is supplied to the machine are embodied independently of the means by which the flavoring is supplied, and located internally of an interchangeable module 6.

Moreover, whilst the invention is described as applicable to a granita dispenser, it might equally be applied to a machine by which chilled beverages, consisting in a blend of water and flavoring, are mixed and dispensed on demand.

Thanks to the modular design of the device to which the present invention relates, the preferred autofill configurations are applicable similarly to multiple bowl machines.

Lastly, given the ease with which it is fitted to and detached from a machine, the device is likewise easily removable for the purposes of maintenance, repair or replacement.

What is claimed is:

1) an autofill device applicable to the mixing bowl of a granita or chilled beverages dispenser, comprising:
a module positionable on the bowl of the dispenser, equipped with feed means conveying water, feed means conveying a liquid flavoring, and connection means located between the bowl and the feed means conveying the water and the flavoring;
electric and electronic control means including a control unit, and sensors able to detect the presence of the flavoring and the water respectively in the feed means or in the connection means, or in both;
sensors serving to monitor the level of the mixture in the bowl and to activate the step of replenishing the bowl with the water and liquid flavoring by way of the respective feed means when enabled by the sensors.

2) A device as in claim 1, wherein the module is coupled both to a water inlet pipe and to a pipe associated with a vessel containing the liquid flavoring, and easily detachable from each of the selfsame pipes.

3) A device as in claim 1, wherein at least the feed means conveying the liquid flavoring include a respective pump of which the operation is piloted by the control unit in response to signals from the level sensor.

4) A device as in claim 3, wherein the feed means conveying the water include a respective pump of which the operation is piloted by the control unit in response to signals from the level sensor.

5) A device as in claim 3, wherein the feed means conveying the water include a solenoid valve of which the operation is piloted by the control unit in response to signals from the level sensor.

6) A device as in claims 1 to 5, wherein the feed means conveying the water and the feed means conveying the liquid flavoring flow into a single mixer pipeline coinciding with the connection means and discharging into the bowl.

7) A device as in claims 1 to 5, wherein the feed means conveying the water and the feed means conveying the liquid flavoring flow into respective first and second pipelines coinciding with the connection means and discharging into the bowl.

8) A device as in claims 1 to 7, wherein the feed means conveying the water and the feed means conveying the liquid flavoring comprise respective lengths of pipeline embodied in electrically non-conductive material, also respective tubular segments of electrically conductive material coupled into the lengths of pipeline, wired to the control unit and functioning thus as sensors able to detect the presence respectively of water and of liquid flavoring in the selfsame lengths of pipeline.

9) A device as in claims 1 to 7, wherein the feed means conveying the water and the feed means conveying the liquid flavoring comprise respective lengths of pipeline with which a first flow meter and a second flow meter are associated, respectively, functioning thus as sensors able to detect the mass or volumetric flow rate of the water and of the liquid flavoring passing along the selfsame lengths of pipeline.

10) A device as in claims 1 to 7, wherein the feed means conveying the water and the feed means conveying the liquid flavoring comprise respective lengths of pipeline of which at least one such length incorporates both the flow metering sensor and the presence sensors.

11) A device as in claims 1 to 10, wherein the module appears outwardly as a modular housing positionable directly on the top of the bowl.

12) A device as in claim 11, wherein the modular housing can be retrofitted to an existing granita or chilled beverages dispenser without the need for any functional modifications to the selfsame dispenser.

13) A device as in claim 6, wherein the water and the liquid flavoring are blended in the single mixer pipeline.

14) A device as in claim 7, wherein the water and the liquid flavoring are blended directly in the bowl.

15) A device as in claims 1 to 14, wherein the module comprises switch means, connected to the control unit, of which the function is to deactivate the device.

16) A device as in claims 1 to 15, further comprising manually operated button means connected electrically to the control unit, by means of which the lengths of pipeline can be filled respectively with water and with liquid flavoring at least to the point of engaging the relative presence sensors or flow metering sensors, or both.

17) A device as in claims 7 and 8, wherein the sensors serving to detect the presence of the liquid flavoring are positioned on the second pipeline, near the point of discharge into the bowl.

18) A device as in claims 1 to 17, further comprising manually operated means, connected by way of the control unit to an electronic device regulating the operation of the pump, such as will allow the flow rate of the pump to be adjusted manually according to requirements.

19) A device as in preceding claims, comprising means by which the absence of one or other ingredient of the product can be indicated optically and/or acoustically.
